(19) United States
(12) Patent Application Publication
(10) Pub. No.: US 2002/0143775 A1
(43) Pub. Date: Oct. 3, 2002

(54) Multi-media management systems

(76) Inventors: Paul D. Wilkinson, Bucks (GB); Suzanne Helen Brody, Harrow (GB); Christopher David Holmes, Bucknell (GB); Mark David Cotton, London (GB); Dave Brown, Buckinghamshire (GB)

Correspondence Address: Erwin J. Basinski, Morrison & Foerster LLP, 425 Market Street, San Francisco, CA, 94105-2482, US

(21) Appl. No.: 10/071,357

(22) Filed: Feb. 7, 2002

(30) Foreign Application Priority Data
Feb. 8, 2001 (GB) 0103139.2

(51) Int. Cl. G06F 7/00; G06F 15/16

(52) U.S. Cl. 707/10; 709/203

(57) ABSTRACT

A computer-based multi-media management system for controlling access to stored multi-media assets utilizing a database, which contains media objects which include video images, still images and text; and a server for enabling the stored assets to be accessed by a user via a communications network, and a taxonomy system allowing a user to access the stored assets, the taxonomy system linking categories of media objects in the database in a hierarchical tree system with each node representing a category, and wherein the management system has, for a selected plurality of media objects as represented by the categories, association links linking categories so that a user can traverse the tree by moving from a first category to a second category which need neither be at the same hierarchical level in the tree or have any form of parent/sibling relationship with the first category.

### RELATED CASES

This application claims priority from United Kingdom patent application 0103139.2 filed Feb. 8, 2001.

### BACKGROUND

The present invention concerns a multi-media management system. It is particularly concerned with the management of media resources in a Web-based environment.

Current technology means that it is now possible to apply and store very substantial volumes of data. Such data can include video data, audio data, still image data and text. In addition the proliferation of Web-based technology enables stored data to be accessed from and transmitted to locations which can be separated by large distances. However, the facilities provided by this technology give rise to major problems as to how the stored data can be accessed, delivered and presented in an economical and efficient manner. For example one problem which can arise is that when a user wishes to access the data it may be from a terminal with limited band-width capability. Thus if the required data is video data an important concern is to be able to ensure that the required data can be delivered over a reasonable time scale and that no unnecessary data is accessed or transmitted.

Another problem is that because modern technology allows great quantities of different types of data to be stored a user can be faced with a very substantial problem when browsing from one media object accessed through the system to another. Often the media objects being accessed are arranged in a hierarchical tree structure with a parent-child relationship between the various layers of the structure. However this type of arrangement can be extremely inefficient to browse as once a user has penetrated a number of layers into the hierarchy relevant data can not be accessed except by retracing steps to a higher level of the hierarchy and then going down another branch.

A multi-media management system of the kind of which the present invention is concerned has many potential applications in which a user might wish to access a multimedia database from a distant location or wishes to store in the multimedia database data just acquired at a location distant from the database.

One example of a potential application is of a television or film producer assembling a program which can be composed of digital video, still images, audio and text from a location where new data is being generated and which is to be combined with data which has already been stored. For example the producer might be moving from a location in one country to another country with a minimal camera team generating new data and at the same time needing to integrate the newly generated data with data stored at a distant main database.

Another example could involve a chain of travel agents wishing to present information of holiday destinations to potential clients in a manner which is both effective and flexible.

Thus whilst the following description gives a specific example of a use of a multi-media management system according to the present invention it has to be appreciated that there are many other fields in which a system according to the present invention can be employed.

### SUMMARY OF THE INVENTION

In accordance with one aspect of the present invention there is provided a multi-media management system, comprising electronic processor for controlling access to stored multimedia assets utilizing database, the database containing a plurality of individual media objects the instantiations of which include video images, still images and text; a server for enabling the stored assets to be accessed via the database by an outside user via a communications network, and an electronic processor controlled taxonomy system allowing a user to access the stored assets via the server, the taxonomy system linking categories of media objects in the database in a hierarchical tree system formed of nodes with each node representing a category, there being a basic parent/sibling relationship between the nodes of the tree, and wherein the management system has, for a selected plurality of media objects as represented by the categories, association links linking categories so that a user can traverse the tree by moving from a first category to a second category which need neither be at the same hierarchical level in the tree or have any form of parent/sibling relationship with the first category.

### DESCRIPTION OF THE DRAWINGS

In order that the present invention may be more readily understood an embodiment thereof will now be described by way of example and with reference to the accompanying drawings, in which:

FIG. 1 is a block diagram of the overall system architecture of a multi-media management system according to the present invention;

FIG. 2 is a block diagram of the server of the system shown in FIG. 1;

FIG. 3 is block diagram of the ingest station of the system shown in FIG. 1;

FIG. 4 is a block diagram of the browser of the system shown in FIG. 1;

FIG. 5 is a block diagram showing the potential paths available to a user in using the management system;

FIG. 6 is a diagram illustrating the manner in which the data in the management system of FIG. 1 is organized;

FIG. 7a is a diagram illustrating a special taxonomy tree utilized in the management system of FIG. 1, FIG. 7b is a diagram illustrating an association link and FIGS. 8 and 9 to 14 are flow diagrams representing sequences of operations of the media management system.

### DESCRIPTION

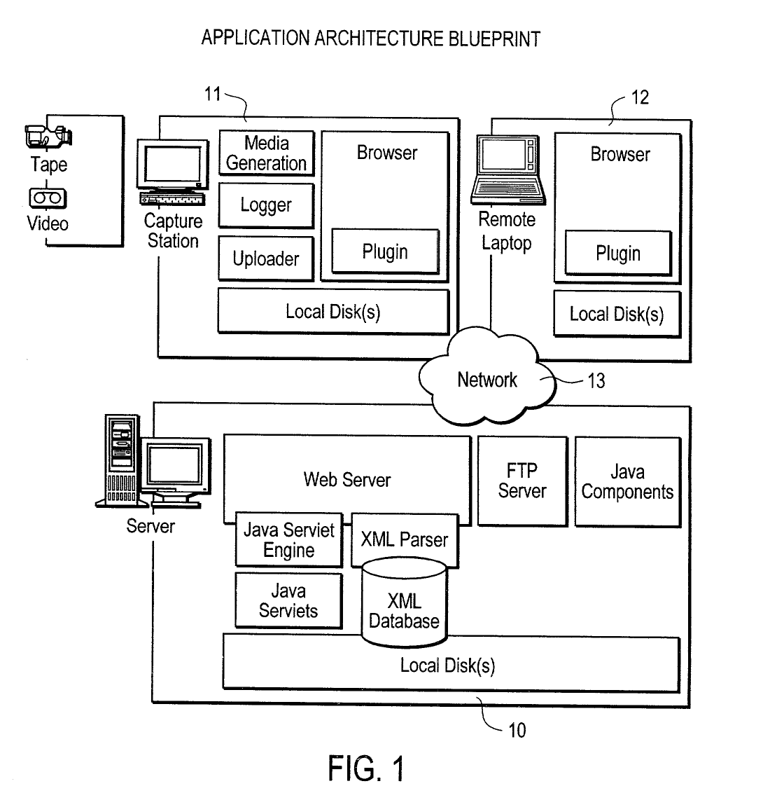

Referring now to the accompanying drawings the multimedia management system shown in FIG. 1 comprises a server 10 in communication with an ingest station 11 and a browser 12. Communication between the server 10 and the ingest station and the server and the browser may be by the Web or a dedicated network and is shown at 13. A particular example of the Web 13 is the Internet but the Web may be any other data transmission system by means of which multi-media objects such as audio, video and text can be transmitted between distant terminals. Whilst FIG. 1 shows only a single ingest station and a single browser it must be appreciated that many ingest stations and browsers may be incorporated in the system. Additionally it must be understood that the system need not necessarily include an ingest station of the kind shown as the latter is merely one type of source for the multi-media data to be managed by the system.

It is of course also possible to combine the facilities of the ingest station with those of the browser so as to provide a combined terminal. The browser, in fact, is included merely as an example of the minimum required by a user in order to usefully access the multi-media database held by the server.

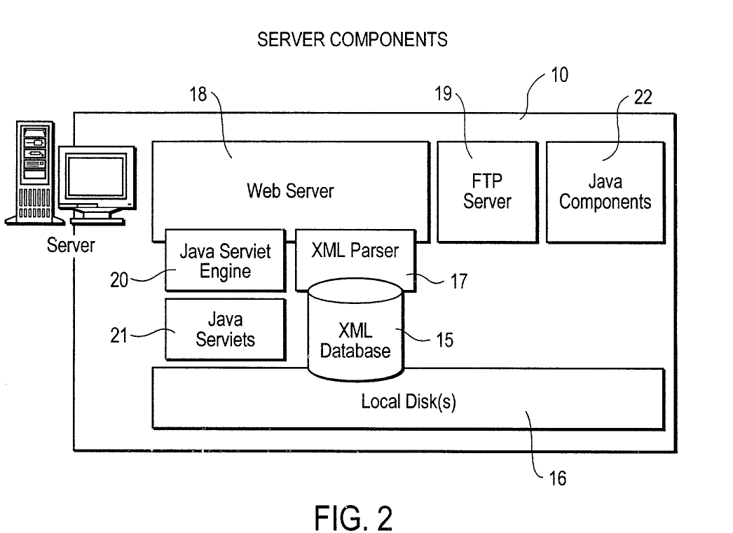

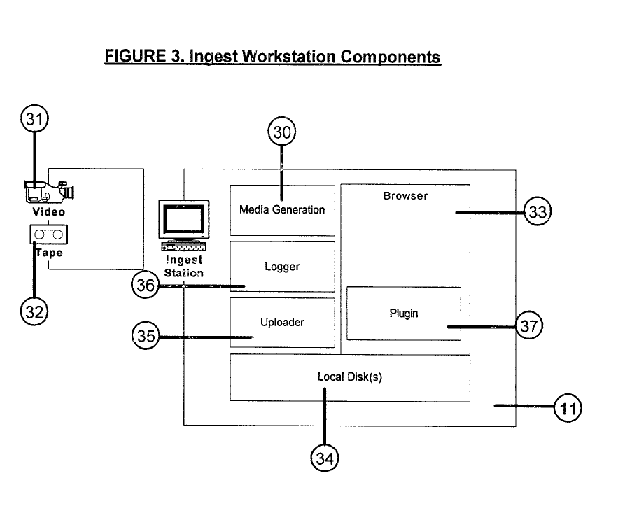

Referring now to FIG. 2 of the drawings this shows the server 10 in greater detail. Thus the server 10 comprises a database 15 supported by local discs 16. In the present embodiment the database is an eXcelon (RTM) document object database which stores in digital form the media objects which are to be accessed by the browser or added to by the ingest station. These media objects provide a user with links to the actual media assets which are to be accessed by a user. As already mentioned the media assets can be video, still images, audio or text. These multi-media assets are stored in a more appropriate mechanism such as a file system.

An example of the hardware configuration of the server is a Hewlett Packard (RTM) LC 2000V personal computer having 2×PIII 533 MHz CPUs, 896 MB RAM, and six Ultra SCSI 10K RPM disks (in a RAID 0 stripe set for speed). Additionally there is provided a HP NetRAID (TM), a 100 Base-T network card. A single gigabit Ethernet network card can be used if extra speed is required.

The software specification for this system is an operating system comprising Microsoft Windows NT Server 4 (Service Pack 6) and a Web server 18 comprising Microsoft Internet information server (IIS) 4. Additionally there is a FTP server 19 in the form of a Microsoft FTP server (part of IIS), a Java servlet engine 20 which is an Allaire JRUN Pro 2.3.3 and various Java servlets 21 and components 22 written by the applicants. The XML parser is a Microsoft (RTM) XML parsing engine, and the XML database is an EXcelon (RTM) B2B Portal Server 2.5.

FIG. 3 of the accompanying drawings shows the ingest workstation 11 in greater detail. The ingest workstation serves as ingest point for loading media objects into the database 15 though it is of course also capable of accessing and viewing data stored in the database. Thus the ingest station 11 includes media generation facilities 31 which in the present embodiment comprise a digital camera for generating video/audio data or still images. In addition the ingest station includes a network browser indicated at 32 by means of which the ingest station can interact with the server over the network 13. Additionally the ingest station will comprise an input port for downloading media generated by the media facilities, local discs 34 for storing media objects downloaded from the stored media assets, an uploader 35 and a logger 36 and a plug-in 37. The uploader 35 in the present embodiment is an application written in Visual Basic that interfaces with the servlets and components 21 of the server. The uploader enables a user to select a file, add descriptive metadata to the file or edit existing metadata about the item and then submit the item to the server.

A typical logger is Virage Videologger (RTM) which enables a user automatically to detect scene changes in a video sequence and define and log shots within the video sequence, adding text such as key words and description.

In the present embodiment the ingest station comprises a Hewlett Packard Kayak XU800 (RTM) personal computer with a 1×PIII 733 MHz CPU, 512MB RAM, 2×18GB SCSI Disks, and a 1×SCSI 3 Ultra Controller. It also includes a CD-ROM, Matrox G400 (RTM) Dualhead Graphics Card, and 2×TFT 124×768 15″ Flat Panel Monitors.

Also included is a plug-in 37. In the present embodiment this comprises an Apple (RTM) Quick Time 4 Player Plugin, and a program which allows the downloading of large sections of context from the databases to a local folder.

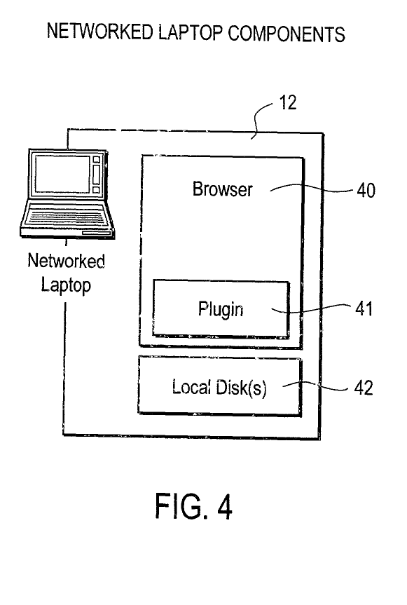

The simplest type of terminal which can interact with the server shown in FIG. 4 is the browser 12. In practice the browser will ideally but not necessarily comprise a powerful portable or laptop computer. The essential components of the browser 12 are shown in FIG. 4 of the accompanying drawings and comprise, apart from the usual keyboard, display screen, internal memory and alternative data input devices such as a mouse or a roller ball, a browser 40, a plug-in 41 and local discs 42. The browser 40 and plug-in 41 are of the same type as those of the ingest station 11.

A typical laptop computer could be a Compaq (RTM) Armada 7400 having a 1×PII MMX266 megahertz CPU with 64 MB RAM, a 7 GB hard disc, a 10-base T network, a 56 K modem and a high resolution color graphic display screen. It will of course be appreciated that the above specification is purely by way of example. There are many other data processing devices available which will provide adequate functionality.

With the browser 12 a user can access the main database at the server in the Web provided that the user does not wish to download and view fully uncompressed video data.

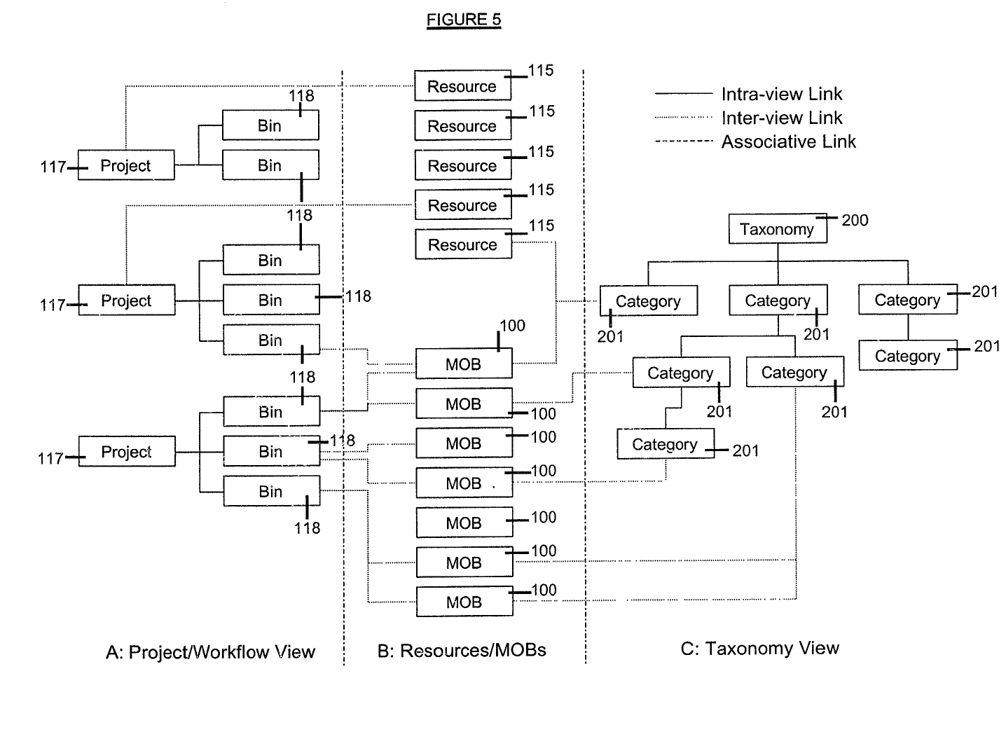

Having described the principle structural features of the multi-media management system FIG. 5 is a diagram setting out the way in which the data handled by the system is organized.

At this stage the core of the system are the media objects or assets which are being stored in the database 15, accessed by the browser 12 and added to by the ingest station 11.

In the present embodiment a user is provided with a very wide choice with regard to the manner in which the assets stored in the database can be browsed or accessed as an important feature of the invention is the way in which links between the assets of the database and a user at an ingest or browser terminal are organized. An important part of the management system which gives this flexibility is referred as “Taxonomy” and will be described in detail hereinafter.

At this point it is worthwhile considering the actual structure of the management system not in terms of physical hardware as shown in FIGS. 1 to 4 but in terms of meaningful relationships concerning the potential paths that a user can follow when utilizing the resources of the database and it is this structure is shown in FIG. 5 of the accompanying drawings.

This figure is divided into three sections labeled A, B and C. Essentially Section A of FIG. 5 represents the view of a user of the management system. Thus a user may initially generate a project or projects 117 and data concerning the or each project will be stored in bins 118. Thus while a project is a common way of working there is no necessity to create one.

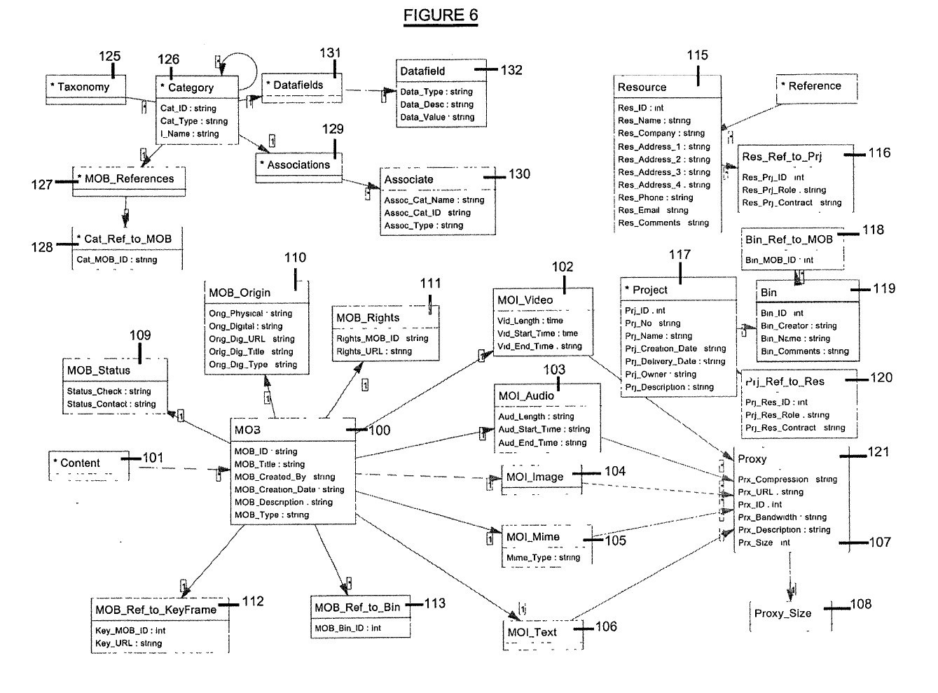

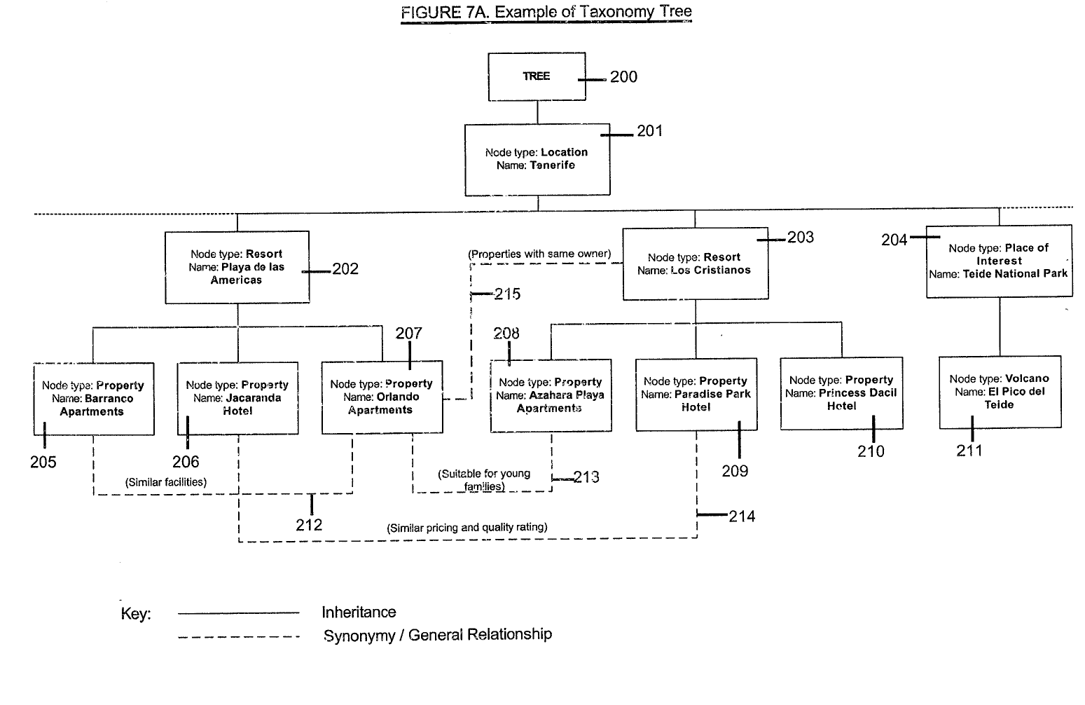

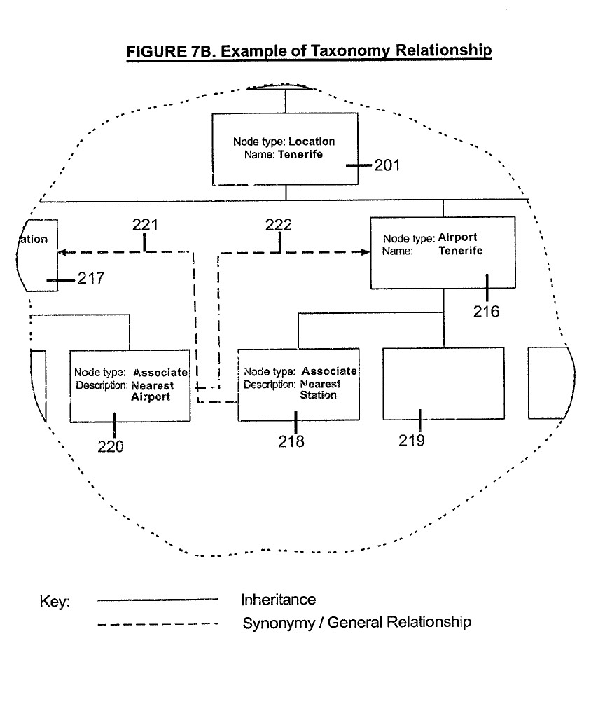

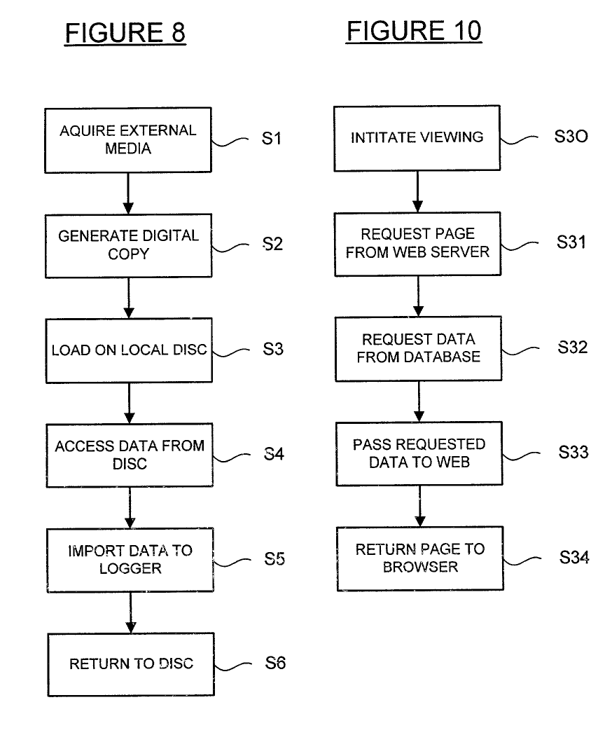

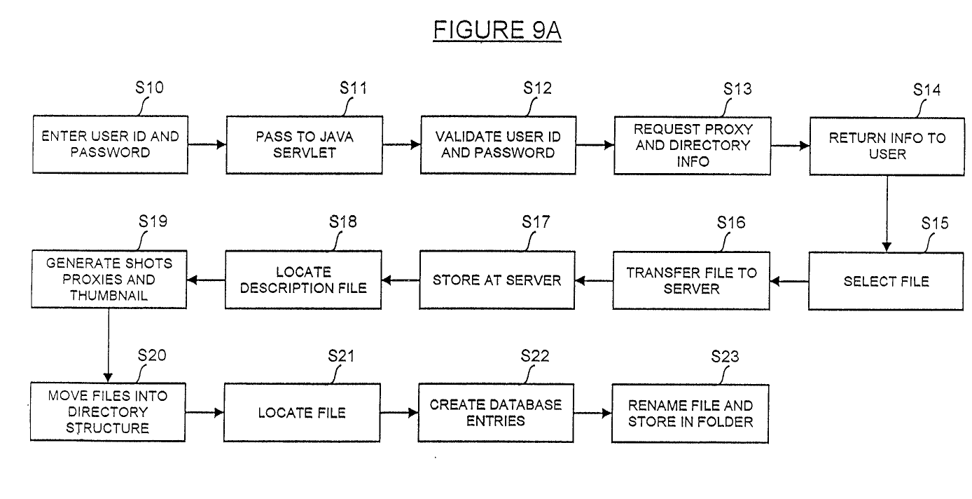

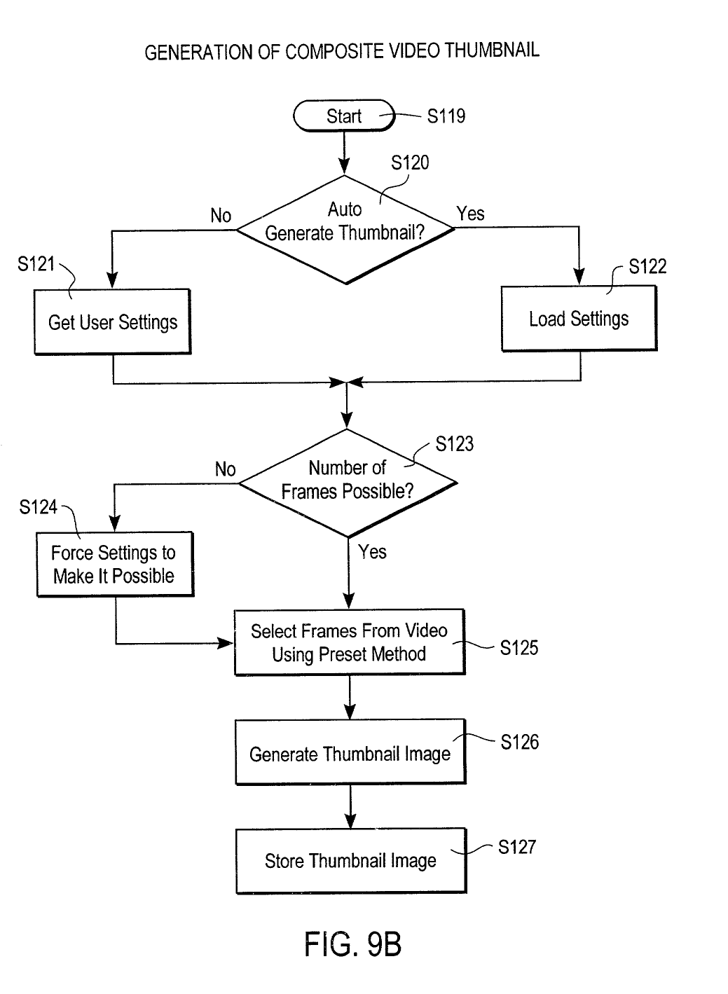

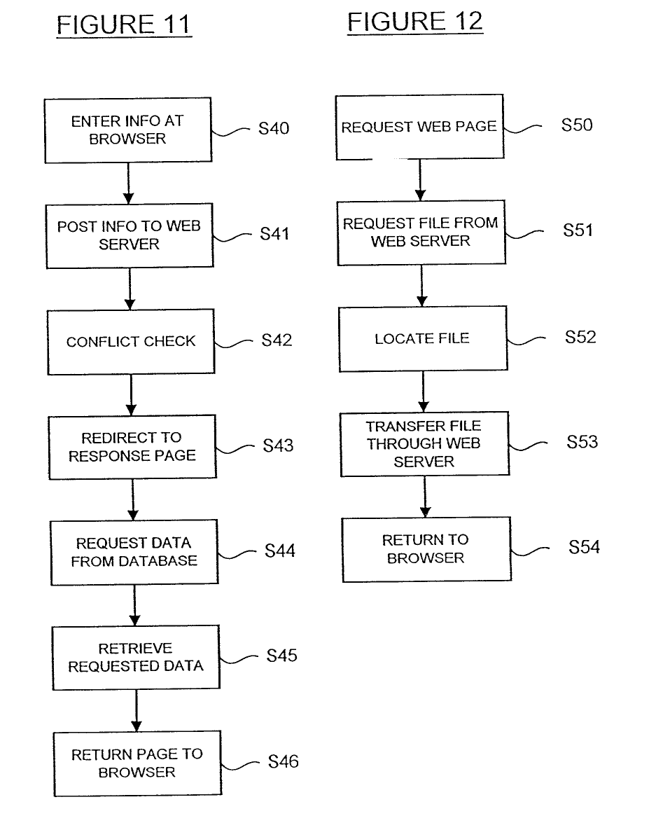

Essentially a project is defined by its name and may be the reason for which a user wishes to access the system. In carrying out a project a user will have one or more bins 118 storing data appropriate to the project and having associated data fields or attributes, as does the project itself. As shown in FIG. 6 associated with each bin may be one or more reference fields 119 which provides the user with a link or links to media objects within the main data base.

In Section B of this FIG. 5 the assets to be accessed by a user are indicated firstly as a series of media objects 100 which will hereinafter be referred to as MOBs. The contents of a MOB can take a wide range of formats such as video, still images and text. Also forming part of the assets are what are shown as resources 115. These may be generated at any time by a user when setting up a project. A resource contains contact information such as, for example, information concerning other people, locations or companies relevant to or useful for the project.

Finally Section C of FIG. 5 relates to the taxonomy of the system, that is a way in which individual MOBs in the database can be accessed by a user. Taxonomy is indicated in this figure and in FIG. 6 by 125.

The features of the taxonomy section will be dealt with in greater detail hereinafter but they include a hierarchical tree 200 having nodes 201 entitled categories. In accordance with the present embodiment the nodes in the tree can be accessed via what are called association nodes. This important feature will be described in detail later.

The representation of FIG. 5 is created using the architecture of FIG. 6 which is a diagram illustrating the manner in which the actual data in FIG. 5 is organized. One such media object or MOB is illustrated at 100. The content of the MOB is shown at 101 and as already described can take a wide variety of formats. The actual media item, such as a still image, a video clip or a passage of audio will be referred to as an instantiation and examples of these are shown at 102, 103, 104, 105 and 106. Thus M01 102 represents a video instantiation, M01 103 audio, M01 104 a still image, and M01 106 text.

An important feature of the management system in the presence of the category represented by M01 105 which in FIG. 6 is marked as MO_MIME. This category is used to cope with data in a format outside the range of formats which cannot be handled by the management system but which can be handled by the browsers.

As can be seen from FIG. 6 each M01 has additional data associated with it represented as an attribute or data field. For example the video M01 103 has associated data which identifies the length of the video and its start and end times.

Another important feature of the media arrangement system being described is the provision of what are called in this specification as proxies.

A single proxy is indicated at 107. Whilst the proxy is shown as being associated with each of the instantiations 102 to 106 this is purely for ease of description and it will be appreciated that each instantiation can have one or more individual proxies associated with it and that no instantiation will have a proxy in common with another instantiation. In essence a proxy is an alternative version of its main instantiation. For example if M01 102 is uncompressed color video it may be extremely difficult or even impossible for a browser to be able to access and download the stored data over a reasonable timescale. Thus the proxy 107 is shown as containing compressed video and has associated with it data identifying the type of compression employed, bandwidth required and the like. Accordingly an MOB stored in the main database can have a plurality of proxies representing different compression formats. Additionally a proxy may represent an identical version of another proxy but which is instead stored in an alternative location.

The size of any one proxy is identified by the proxy size data field shown at 108. It will be appreciated that it is possible for proxies to be stored at more than one location. Thus whilst the present embodiment has a single database there may be a plurality of data bases at different locations, even in different countries. Nor is it a requirement that each database is identical. For example some proxies may not be present in every database.

In order to access the database each MOB has associated with it a plurality of description fields or attributes which are indicated by reference numerals 109 to 113. Field 109 indicates the status of the MOB, 110 its origin, 111 any rights such as copyright which may be associated with the MOB and which might limit or prevent its dissemination, 112. The step of generation the thumbnail of a video sequence is an important feature of the present invention. It is to be appreciated that a video content is stored as a sequence of frames and previously a thumbnail would be a selected one of these frames. In the present embodiment the thumbnail can be generated as an image formed from a selected number of frames displayed simultaneously but separately as a composite image with the displayed frames representing a sequence of events. FIG. 9b is a flow diagram of this procedure which will be described along with the other flow diagrams which form part of the specification. Finally 113 indicates a reference to a bin 119. The reason for this is that each bin may have a reference to a MOB and conversely the MOB will have a reference to that bin.

Another particularly important component in the data structure illustrated in FIG. 6 is that shown as taxonomy. Taxonomy is indicated at 125. It Must be appreciated that in the present embodiment the purpose of the MOBs is not to contain the actual instructions, which exist in the real worlds, but merely to those instantiations.

In order to clarify exactly what is meant by an “instantiation” it must be understood that it need not be actual stored data such as video, still images or text which is fixed. For example, an instantiation might be a link to an instantiation input defined by its category 126, which includes ID, type and name fields in the form of strings. A category is merely a node in the tree hierarchy shown in FIG. 5 and the category may have, as shown by the arrow, got at least one sub directory. Associated with each category 126 is a MOB reference 127 linked to the MOB in the database by its data fields. A particularly important part of the taxonomy structure is what is shown in FIG. 6 as “associations” 129.

It is these associations which enables the user to access the database in a particularly flexible manner which will be described hereinafter. By means of the associations the user can access other assets in a simple manner. Each association has its individual set of data fields indicated at 130. Each category is described by its data fields 131 and 132.

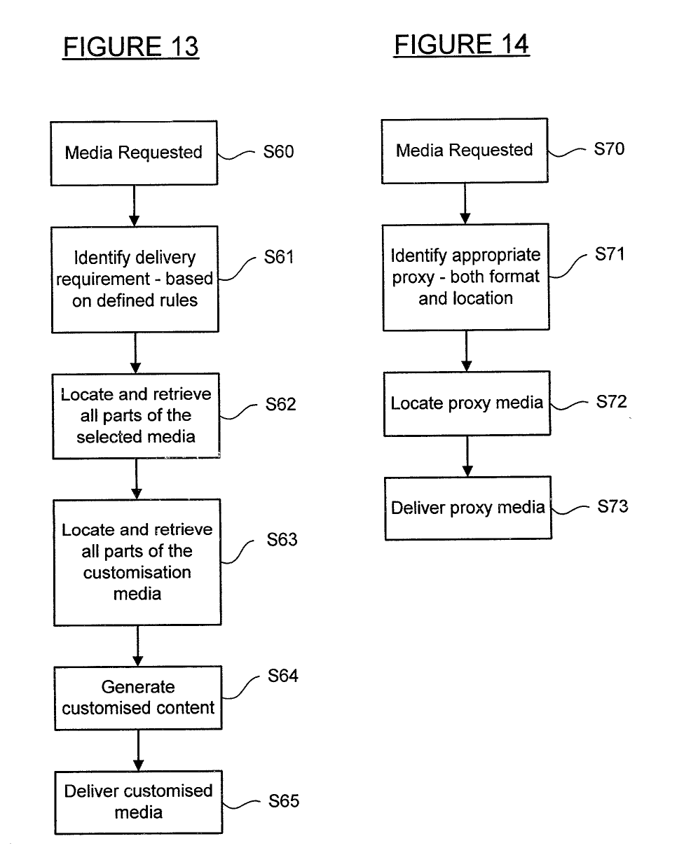

FIG. 7 of the accompanying drawings shows an example of a taxonomy tree that can be traversed by the management system at the request of a user, for example via the browser of FIG. 4.

As can be seen the structure is basically the well-known one of a tree, indicated at 200. Only a part of a tree is shown but as is commonplace the tree has a hierarchical array of levels with each level having one or more parent nodes each of which, unless it is the final node of a branch, has one or more child nodes associated with it.

Thus in the taxonomy tree shown in FIG. 7 the data to be accessed is of the kind which might be used by a travel agent who wishes to provide information to a potential customer. Accordingly the first node shown in the tree is node 201. Each of the nodes shown has an associated field indicating the type of the node and node 201 is a location node. Thus it refers to a specific location, Tenerife, by means of which it can be assessed by a user. Naturally in other situations the type of the node could be a country, a game such as rugby or football or a composer. Naturally the location Node 201 shown in FIG. 6 could itself be a child node linked to, for example, a parent node defining a country.

In the present embodiment the general location Tenerife, as represented by the parent node 201, has a series of dependent or child nodes 202, 203 and 204. Of course there could be many more or less than three child nodes for any parent node.

Again in the present embodiment two different types of child node are shown. Thus nodes 202 and 203 refer to actual resort towns in Tenerife respectively. Playa de las Americas and Los Cristianos are resorts which are found in Tenerife. However node 204 is not to a village but to a place of interest. Once again for a different scenario it will be appreciated that given a different parent node the nodes 202, 203 and 204 could be different subjects of an entirely different range of subject matter.

Each of the nodes 202, 203 and 204 are in turn parent nodes for a next set of child nodes in the tree hierarchy.

These nodes 205 to 211 again have different “type” fields. In the case of nodes 205 to 207 they refer to properties available to a customer at the resort of Playa de las Americas, whilst nodes 206 to 208 refer to properties available at Los Cristianos. Naturally each node has the name of the relevant property associated with it. Node 204, which refers to a place of interest rather than a resort, has in this embodiment only one child node which refers to the actual attraction, namely a volcano. Once again it will be appreciated that these subsidiaries are only by way of example. However the taxonomy tree shown in FIG. 7 has, as pointed out in the description of FIG. 6, another particularly important feature in that it is also possible to traverse the tree not merely by direct parent-child links which effectively means descending deeper and deeper into the hierarchy but by moving from one branch of the tree such as that formed by nodes 201-202-205 to another branch having the same parent node. In this embodiment this procedure is shown by the chain dotted line 212 leading from node 205 to node 207. This cross-link 212 will be referred to as an association link and in the tree being described indicates that the properties of the nodes 205 and 207 have similar facilities.

In a similar fashion the association link 213 links nodes which do not have the same immediate parent node. In the case of link 213 the association is that the properties of the two linked nodes are suitable for young children.

As will be appreciated the concept of these association links can be expanded along with the requirements of the particular scenario. Thus the association link 214 in FIG. 7 indicates that the two properties, though in different resorts are of similar pricing and quality rating.

Another powerful feature of the taxonomy tree shown in FIG. 5 and in FIG. 7 is the concept of association links between nodes which are at different levels in the tree hierarchy. As an example of this is the association link 215 between nodes 203 and 207 in FIG. 7. Purely by way of example this association link 214 indicates that the owner of the property Orlando Apartments also has properties in Los Cristianos.

It is thus possible for a browser, or a person displaying the data to a user to be able to traverse the tree hierarchy without the necessity of having to retrace steps to a common parent node. This greatly contributes to ease of use.

How the association links 212, 213, 214 and 215 in FIG. 7A are implemented will now be described in greater detail with regard to FIG. 7B. This figure is part of the incomplete taxonomy as shown in FIG. 7A and includes node 201 (Tenerife) as a parent node. Node 201 has sibling nodes 216 and 217 with node 216 representing Tenerife airport. Node 216 is parent to two nodes 218 and 219 and node 217 is a location node and parent to a node 220. Node 219 is a normal sibling node and in the present diagram is not itself a parent to any other nodes. However nodes 218 and 220 will now be referred to as association nodes in that they are linked by separate association links 221 and 222 to nodes 217 and 216. As shown in FIG. 7B these association links are “one way”; that is node 217 can be accessed by node 218 but node 218 cannot be accessed by node 217.

Similarly node 216 can be accessed by node 220 but cannot itself access node 220 even though it is higher in the tree hierarchy. It is however entirely possible to make both nodes 216 and 220 association nodes so that node 216 can access node 220. As already mentioned the provision of these association nodes, greatly improves the range of possibilities open to users of the database.

Having described the basic hardware of the multi-media management system, the manner in which the data is organized and features of the taxonomy system reference will now be made to flow diagrams illustrating the basic functions of the system.

Firstly a description will be given of the flow diagram of FIG. 8 of the accompanying drawings.

This flow diagram relates to the steps followed when ingesting data at the ingest station shown in FIG. 2.

At step S1 external media is brought in on tape, straight from the camera on some form of digital storage such as CD ROM, DVD or transferable disk. It should be noted that the means of transferring media into the system is not relevant to functionability.

Step S2 depends on the format of the original context and in this step a digital copy of the media is generated using standard NT utilities. In the present embodiment Microsoft (RTM) VidCap is used to ingest video from the camera which is interfaced with a DV Capture card.

After generation the actual media file generated in step S2 is loaded into a local (or fast SAN) disc in order to reduce the requirement for uninterrupted bandwidth.

In order to log the data using the logger facility available at the ingest station the stored media file is accessed at step S4 from its store location and at step S5 it is imported into the logger facility. In step S6 the user edits the ingested data, and the resulting edited data is returned to the storage media for subsequent use. For example, in editing the data it can be broken up into separate slots and each slot have descriptive metadata attached to it before it is returned to the storage media.

The next flow diagram, FIG. 9a, sets out the procedures followed when uploading data from the ingest station to the server.

At step S10 the user at the ingest station starts the upload application and is required to enter a user ID and password. This is passed at step S11 to a Java Servlet “Login” through the Web server and the Java Servlet engine. The servlet validates the user ID and password at step S12 and returns to the user confirmation that the request has been allowed.

At step S13 the upload application requests information about the available proxy formats and directories of the server database and at step S14 the servlet returns to the user at the ingest station information regarding the types of media that can be created at the server and the locations for uploading media and data to the ingest station.

At step S15 the user selects a file to be uploaded and the application connects the FTP server using the parameters previously returned by the servlets. As a result the required media and data are transferred at step S16 from the ingest station to the server for storage at step S17 in the local discs of the server.

At step S18 the Java component scans the uploads area of the database and locates the description file. This file contains information concerning the annotated context file and the shots, descriptions and proxies that are to be generated. After step S18 the Java component works through the description file and at step S19 generates the required shots and proxies together with a thumbnail. The generation of a thumbnail is intended to enable a user to identify visually the contents of a video MOB without having to actually download and display the video as this may be too time intensive or the bandwidth available between the user and the video source too limited. Previously thumbnails have consisted of a simple frame of the video sequence, this frame normally being selected from the start of the sequence.

In accordance with the present invention a user has the opportunity either to select a single frame or for the software to generate a composite image showing a sequence of temporarily spaced frames. For example four frames could be selected, namely the first and last frames having video data, and two intermediate frames. Thus when the thumbnail is displayed a single still image would be shown consisting of the four selected frames. The procedure to be followed in achieving this is shown in the flow diagram of FIG. 9b and will be described later. Finally at step S20 the content files are moved into the correct directory structure and the description file is moved into a new location for the next stage of the process.

It is still necessary to create database entries for the content which has been loaded from the ingest station.

This is done at step S21 where the Java component locates the process description file and works through the information contained in it. At step S22 entries are created in the XML database for the corresponding context and proxies and the approximate metadata is included. Finally at step S23 the description file is renamed and stored to a new folder.

In the flow diagrams of FIG. 9b the start of thumbnail generation is shown at step S119. At step S120 a choice is made between manual selection of a frame or autogeneration of a composite thumbnail image. If manual operation is selected the user inputs the required settings at step S121, and if automated generation is selected the number of frames to be used is loaded at step S122. As some video sequences may be very short step S123 decides if the number of frames available is sufficient and if not the setting are forcibly attached at step S124 to be sufficient. At step S125 the frames to be used in the composite image are selected using the final setting. Finally at steps 126 and 127 the composite image is generated and stored.

As a result of the operations which have just been described the structural media data is now available for access by the browser described with regard to FIG. 4. The steps followed by a user of the browser are set out in the flow diagrams of FIG. 10.

At step S30 the user initiates the viewing of an HTML or ASP page. The browser requests the page from the Web server at step S31 using HTTP protocol.

If data is required from the database a request is made through the ASP/UB script to the eXcelon server for the information. This is done in step S32. At step S33 the data retrieved from the database is passed through an XSL, if required, and passed back to the Web server to be incorporated into the page. Finally at step S34 the page is returned to the browser at HTML.

It is of course also necessary to be able to update the database. This can be done via either the ingest station or the browser. The procedure to be followed is set out in the flow diagram of FIG. 11.

At step S40 the user at either the ingest station or the browser enters information in the Web page. The browser posts the Information with the page to the Web saver using the standard HTTP protocol at step S41.

At the Web server the request is handled by a servlet that checks to ensure that the information being entered does not conflict with information already present. For example it prevents the creation of two projects with identical names. This is done at step S42. Preferably all servlets log the actions they perform to a special location memory to provide an audit trace. At step S43 the servlet redirects to a response page depending on whether or not the updates are successful. If data is required from the database for the response page, a request is made through the ASP/NVBS script to the eXcelon server for the information at S44.

At step S45 data retrieved from the XML database is passed through the XML, style sheet and then passed back to the Web Server to be incorporated into the page. Finally at step S46 the page is returned to the browser as HTML.

It is also necessary for a user at a remote location to view events available in the database. As with the previous flow diagram the procedures to be followed are the same for both the ingest station and the browser. The procedures followed are set out in the flow diagram of FIG. 12.

Thus in step S50 the user enters a request for a Web page and at step S51 the relevant browser requests the file from the Web server using the standard HTTP protocol. This request is handled by a servlet which will present the data in a suitable manner. Thus at step S52 the servlet locates the file using the URL sent to it by the Web browser and transfers the located file at step S53 back through the Web server along with the MIME type. At step S54 the located event is returned to the browser as a binary MIME file.

A feature available to clients using the management system just described is that certain clients may request that the media once delivered be branded with proprietary information such as logos. For example the database might serve several travel agent clients who might request an image of a resort but wish to have this image combined with their own logo, an introductor or soundtrack advertising material. This feature is provided by the flow diagram of FIG. 13.

In step S60 of this flow diagram media is requested by the client as set out in the flow diagram of FIG. 12.

At step S61 the system identifies the delivery requirements from a set of pre-configured rules for example what is the client's physical location? Has the request come from 3rd party portal? and at step S62 the system locates the media that has actually been requested by the client. The next step S63 is to locate the necessary customization components of the final video such as Intro and Outro video, branding watermark. At step S64 the customized media is generated from the components of the media plus any other method such as adding text and finally at step S65 the finished media is delivered to the client. It should be appreciated that the media may be delivered in “real time”, that is it may be generated and delivered or “streamed” simultaneously.

Another important feature of the embodiment described is the provision of proxies. FIG. 14 of the accompanying drawings is a flow diagram illustrating proxy handling when a request for stored media is made from an outside terminal such as the browser.

This flow diagram is of course linked with the flow diagram of FIG. 12. Thus at step S70 of FIG. 14 the media is requested to be downloaded or viewed by the client, and at step S71 the system identifies the delivery requirements from a set of pre-configured rules such as what is the network connection to the client? What is the client's physical location? At step S72 the most suitable proxy of the media is located for example this may be a low bit-rate version for slow connections or may be a full bit-rate proxy stored that is physically close to the client. Finally at step S73 the appropriate media is delivered to the client.

1. A multi-media management system comprising;
an electronic processor for controlling access to stored multi-media assets utilizing a database, the database containing a plurality of individual media objects the instantiations of which include video images, still images and text;
a server for enabling the stored assets to be accessed via the database by an outside user via a communications network, and an electronic processor controlled taxonomy system allowing a user to access the stored assets via the server, the taxonomy system linking categories of media objects in the database in a hierarchical tree system formed of nodes with each node representing a category, there being a basic parent/sibling relationship between the nodes of the tree, and
wherein the management system has, for a selected plurality of media objects as represented by the categories, association links linking categories so that a user can traverse the tree by moving from a first category to a second category which need neither be at a same hierarchical level in the tree or have any form of parent/sibling relationship with the first category.

2. The multi-media management system according to claim 1, wherein selected nodes of the tree are association nodes with each association node providing a one-way link to another node of the tree so as to provide an association link between nodes.

3. The multi-media management system according to claim 2, wherein selected association nodes can be linked so as to provide a two-way access between the nodes via association links.

4. The multi-media management system according to claim 1, wherein a plurality of media objects in the database have associated proxies, a proxy being a representation of an original instantiation of the media object in a different format or location.

5. The multi-media management system according to claim 4, wherein when an instantiation is video data, a proxy is a compressed form of the video data.

6. The multi-media management system according to claim 5 wherein the processor, in response to a request for downloading media having at least one proxy, determines whether or not the media or a selected proxy is to be downloaded.

7. The multi-media management system according to claim 1 adapted to generate and store a thumbnail of a video instantiation, the thumbnail being composed of an integer number of frames of the video instantiation, separately displayed in a single display frame, the integer number of frames being separated one from the other by intervening frames in the original video or film.

8. The multi-media management system according to claim 1 wherein, in response to a request for stored media, the electronic processor is adapted to check the parameters of the request and to customize requested media when it is displayed or downloaded in response to a determination by the parameter check that such customization is required.

9. The multi-media management system according to claim 8 adapted to check the origin of request for access to stored media and to customize the media when it is delivered.

10. The multi-media management system according to claim 1 further comprising at least one ingest station for generating media for storage in the management system, the ingest station having a browser compatible with a Web server, recording equipment for generating video/audio data, and a logger for editing recorded data.
